(19) United States
(12) Patent Application Publication
(10) Pub. No.: US 2025/0320170 A1
(43) Pub. Date: Oct. 16, 2025

(54) COATED FERTILIZER, METHOD FOR PREPARATION AND USE THEREOF

(71) Applicant: UPM-KYMMENE CORPORATION, Helsinki (FI)

(72) Inventors: Suvi PIETARINEN, Helsinki (FI); Ibrahim KAMARA, Helsinki (FI)

(21) Appl. No.: 18/873,610

(22) PCT Filed: Jun. 28, 2023
(86) PCT No.: PCT/FI2023/050400

§ 371 Date: Dec. 10, 2024

(30) Foreign Application Priority Data
Jun. 30, 2022 (FI) 20225610

(51) Int. Cl. C05G 5/35; C05G 3/40; C05G 5/30

(52) U.S. Cl. CPC C05G 5/35; C05G 3/40; C05G 5/37; C05G 5/38

(57) ABSTRACT

The present disclosure relates to a controlled release coated fertilizer product comprising a fertilizer granule core and a coating of readily biodegradable components and natural polymers. The coating comprises an inner layer comprising lignin and a hydrophobic outward layer. The present disclosure further concerns a method for preparing a coated fertilizer product and the use of the coated fertilizer for controlled release of nutrients in farming.

### CROSS REFERENCE TO RELATED APPLICATIONS

This application is a National Stage application of PCT/FI2023/050400, filed Jun. 28, 2023, which claims the benefit of Finnish Patent Application No. 20225610, filed Jun. 30, 2022, both of which are incorporated by reference in their entirety herein.

### FIELD OF THE DISCLOSURE

The present disclosure relates to a controlled release coated fertilizer product comprising a fertilizer granule core and a coating of readily biodegradable components and natural polymers. The coating comprises an inner layer comprising lignin and a hydrophobic outward layer. Particularly, the present disclosure relates to a coated fertilizer product wherein the lignin of the inner coating is trapped within a biobased polymer which is biodegradable. The present disclosure further concerns a method for preparing a coated fertilizer product and the use of the coated fertilizer for controlled release of nutrients in farming.

### BACKGROUND OF THE DISCLOSURE

Increase in global population has led to increase in the food production. This means that the agricultural sector is bound to use large quantities of fertilizers for food production which will further contribute to the hazardous gaseous emissions and water eutrophication already associated with use of fertilizers. These added to the limited availability of arable land, controlled release fertilizers (CRF) are being employed to enhance crop production (by reducing the loss of nitrogen through volatilization and leaching) while limiting the environmental pollution caused using large quantities of fertilizers.

As the name suggests, CRFs allow for controlled release of nutrients to the plants and is usually achieved by coating water soluble fertilizer granules with a protective (semi-permeable, semi-impermeable, or water-insoluble) membrane. Several polymers have been used as coating materials for fertilizers, however; cost, biodegradability, and toxicity of these materials have been major drawbacks in their usage. To overcome these challenges, the use of renewable and bio-based resources, such as natural polymers and biodegradable synthesized polymers, is getting more attention. Among these natural polymers is lignin, which along with cellulose and hemicellulose are the main constituents of a plant cell and is the second most abundant biopolymer after cellulose.

The two main lignin resources today are the paper industry and biorefineries. About 70 million tonnes of lignin are produced annually by Kraft pulp mills. Most of this lignin is used as fuel for the operations of the mills. The world production of unused Kraft lignins as fuel is about 0.1 million tonnes, whereas that of sulphur-free lignins is less than 5000 tonnes. Lignin has attracted interest in the field of materials due to its low cost, non-toxicity, varied functional groups, renewability and degradability. However, due to the complex nature of its structure, the use of lignin in large scale applications has been limited.

Despite the ongoing research and development of processes for producing controlled release fertilizers, especially from natural polymers or biodegradable polymers, there is still a need to overcome the challenges associated with the use of bio-based resources in the production of controlled release fertilizers.

### BRIEF DESCRIPTION OF THE DISCLOSURE

An object of the present disclosure is to provide a controlled release coated fertilizer product and a method for preparing a controlled release coated fertilizer.

The object of the disclosure is achieved by a product, method and use which are characterized by what is stated in the independent claims. The preferred embodiments of the disclosure are disclosed in the dependent claims.

The disclosure is based on the idea of providing a coated fertilizer product and a method for preparing a coated fertilizer, where the coating of the fertilizer comprises, an inner layer comprising lignin, and a hydrophobic outward layer.

More in detail the disclosure is based on the idea of providing a coating consisting solely of non-toxic, readily biodegradable components and/or natural polymers. This means that the coating comprises no organic solvents, no use of non-readily biodegradable co-polymers containing microplastics and that the lignin itself is not chemically modified.

An advantage of the product, method and use of the disclosure is that no microplastics remain in the soil from the biodegradable coating after the fertilizers have been dissolved, since no plastic type non-readily biodegradable polymers are used.

Further, since no organic solvent are used, and the biobased polymer, plasticizer and optional stabilizer(s) and/or thickening agent(s) are preferably water-soluble, a further advantage of the product, method and use of the disclosure is that the drying and coating is easier.

A further advantage of product, method and use of the disclosure is that improved controlled release of the fertilizer product is provided. Preferably the controlled release period, the release rate (conductivity over time) and weight loss of the controlled release fertilizer product is improved.

### BRIEF DESCRIPTION OF THE DRAWINGS

In the following the disclosure will be described in greater detail by means of preferred embodiments with reference to the accompanying drawings, in which

FIG. 1 shows the release rate as conductivity against time for coated fertilizers according to the disclosure and comparative examples; and

FIG. 2 shows the release rate as weight loss against time for coated fertilizers according to the disclosure and comparative examples.

### DETAILED DESCRIPTION OF THE DISCLOSURE

The disclosure relates to a coated fertilizer product wherein the coated fertilizer product comprises a fertilizer granule core and a coating of readily biodegradable components and/or natural polymers and wherein the coating comprises an inner layer comprising lignin and a hydrophobic outward layer.

The coated fertilizer product of the disclosure, and the coated fertilizer obtained by the method of the disclosure, is a coated fertilizer product for controlled release of fertilizer. Typically, the coated fertilizer product has a controlled release period over 4 days, preferably over 30 days, more preferably over 3 months and most preferably over 6 months.

The disclosure also relates to a method for preparing coated fertilizer, where the fertilizer has a coating of readily biodegradable components and/or natural polymers and wherein the method comprises using a coating dispersion comprising lignin, biobased polymer and plasticizer for coating fertilizer granules to provide a coating inner layer and obtaining a one-layer coated fertilizer which is then coated by a outward layer, which is hydrophobic. The biobased polymer and the plasticizer are biodegradable. A coated fertilizer is obtained.

The disclosure further relates to the use of the coated fertilizer product, or the coated fertilizer prepared by the method, for controlled release of nutrients in farming and as a soil improver, preferably in turf, crop cultivation, greenhouse farming and/or ornamental gardening. The coated fertilizer product, or the coated fertilizer prepared by the method is administered either by topdressing the soil, or by mixing the fertiliser into the soil before sowing.

In the context of this specification, the term “lignin” refers to lignin originating from any suitable lignin source. The term “lignin which has not been chemically modified” refers to lignin which has not been chemically modified after extraction of the lignin. Generally, lignin is classified into three main categories: softwood, hardwood and annual plants. Lignin is a complex polymer and has varying chemical structures even within a species. It consists of three phenylpropane units where p-hydroxyphenyl alcohol (H), guaiacyl alcohol (G), and syringyl alcohol (S) are the main precursors (monolignol monomers), interconnected heterogeneously via several types of C—C and C—O linkages. Ether bonds account for 60-70% of the bonds between phenylpropane units, the most common being the β-O-4 bond. But other types of bonds exist, such as α-O-4 or C—C bonds. For the latter, these are mainly 5-5, β-5 or β-β′ bonds. Lignin contains many functional groups some of which are conjugated, this allows absorption of UV rays which gives wood its colour. Softwoods have, on average, a higher lignin level than hardwoods. Softwood lignin has a higher proportion of guaiacyl alcohol, while in hardwoods they are mostly syringyl alcohols. This has an influence on the chemical groups that end up in lignin. Thus, the softwoods will have more hydroxyl groups while the hardwoods will have more methoxyl groups.

In some embodiments of the disclosure, the lignin is essentially pure lignin. By the expression “essentially pure lignin” should be understood as at least 70% pure lignin, or at least 90% pure lignin, or at least 95% pure lignin, or at least 98% pure lignin. The essentially pure lignin may comprise at most 30%, or at most 10%, or at most 5%, or at most 2%, of other components and/or impurities. Extractives and carbohydrates such as hemicelluloses can be mentioned as examples of such other components.

Typically, the lignin contains less than 30 weight-%, or less than 10 weight-%, or less than 5 weight-%, or less than 3 weight-%, or less than 2.5 weight-%, or less than 2 weight-% of carbohydrates. The amount of carbohydrates present in lignin can be measured by high performance anion exchange chromatography with pulsed amperometric detector (HPAE-PAD) in accordance with standard SCAN-CM 71.

The ash percentage of lignin is typically less than 7.5 weight-%, or less than 5 weight-%, or less than 3 weight-%, or less than 1.5 weight-%. The ash content can be determined in the following manner: Dry solid content of the sample is determined first in an oven at 105° C. for 3 h. Ceramic crucibles are pre-heated to 700° C. for 1 hour and weight after cooling. A sample (1.5 g-2.5 g) is weighted into a ceramic crucible. The crucible with a lip is put into a cold oven. Temperature of the oven is raised: 20-200° C. 30 min=>200-600° C., 60 min=>600-700° C., 60 min. Burning is continued without the lid at 700° C. for 60 min. The crucible is let to cool in desiccator and few drops of hydrogen peroxide (H2O2, 30%) is added to the sample followed by burning in the oven at 700° C. for 30 minutes. If there are still dark spots in the ash, the hydrogen peroxide treatment and burning is repeated. The crucible is cooled down and weighted. All weigh-in is done with a precision of 0.1 mg and after cooling in a desiccator.

### Calculation of the Results

$$Ash content \% = ( 100 a \times 100 ) / ( b \times c )$$

wherein
a=weight of the ash, g
b=weight of the sample, g
c=dry solids of the sample, %

Ash content of a sample refers to the mass that remains of the sample after burning and annealing, and it is presented as percentage of the sample's dry content.

In some embodiments of the disclosure, the lignin is technical lignin. In the context of this specification, the term “technical lignin” refers to lignin that is derived from lignin in any biomass by any technical process. In one embodiment, technical lignin is lignin received from an industrial process.

The lignin used for preparing coating dispersion is typically selected from a group consisting of Kraft lignin, steam explosion lignin, biorefinery lignin, supercritical separation lignin, hydrolysis lignin, flash precipitated lignin, biomass originating lignin, lignin from alkaline pulping process, lignin from soda process, lignin from organosolv pulping, lignin from alkali process, lignin from enzymatic hydrolysis process, and any combination thereof. In one embodiment, the lignin is wood-based lignin. The lignin can originate from softwood, hardwood, annual plants or from any combination thereof and typically the lignin has not been chemically modified after extraction of the lignin.

The term “flash precipitated lignin” should be understood in this specification as lignin that has been precipitated from black liquor in a continuous process by decreasing the pH of a black liquor flow, under the influence of an over pressure of 200-1000 kPa, down to the precipitation level of lignin using a carbon dioxide based acidifying agent, preferably carbon dioxide, and by suddenly releasing the pressure for precipitating lignin. The method for producing flash precipitated lignin is disclosed in patent application FI 20106073. The residence time in the above method is under 300 s. The flash precipitated lignin particles, having a particle diameter of less than 2 μm, form agglomerates, which can be separated from black liquor using e.g. filtration. The advantage of the flash precipitated lignin is its higher reactivity compared to normal Kraft lignin. The flash precipitated lignin can be purified and/or activated if needed for the further processing.

The lignin may be derived from an alkali process. The alkali process can begin with liquidizing biomass with strong alkali followed by a neutralization process. After the alkali treatment, the lignin can be precipitated in a similar manner as presented above.

The lignin may be derived from steam explosion. Steam explosion is a pulping and extraction technique that can be applied to wood and other fibrous organic material.

By “biorefinery lignin” is to be understood in this specification, unless otherwise stated, lignin that can be recovered from a refining facility or process where biomass is converted into fuel, chemicals and other materials.

By “supercritical separation lignin” is to be understood in this specification, unless otherwise stated, lignin that can be recovered from biomass using supercritical fluid separation or extraction technique. Supercritical conditions correspond to the temperature and pressure above the critical point for a given substance. In supercritical conditions, distinct liquid and gas phases do not exist. Supercritical water or liquid extraction is a method of decomposing and converting biomass into cellulosic sugar by employing water or liquid under supercritical conditions. The water or liquid, acting as a solvent, extracts sugars from cellulose plant matter and lignin remains as a solid particle.

The lignin may be derived from a hydrolysis process. The lignin derived from the hydrolysis process can be recovered from paper-pulp or wood-chemical processes.

The lignin may originate from an organosolv process. Organosolv is a pulping technique that uses an organic solvent to solubilize lignin and hemicellulose.

In some embodiments of the disclosure, the lignin consists of Kraft lignin, such as softwood Kraft lignin. In one embodiment, the lignin is softwood Kraft lignin. In some embodiments of the disclosure, the lignin is a combination of softwood lignin and hardwood lignin, typically at most 30 weight-%, or at most 25 weight-%, or at most 10 weight-%, or at most 5 weight-% of the lignin originates from hardwood. In some embodiments of the disclosure the lignin consists of EH lignin and/or the lignin is EH lignin derived from hardwood.

By “Kraft lignin” is to be understood in this specification, unless otherwise stated, lignin that originates from Kraft black liquor. Black liquor is an alkaline aqueous solution of lignin residues, hemicellulose, and inorganic chemicals used in a Kraft pulping process. The black liquor from the pulping process comprises components originating from different softwood and hardwood species in various proportions. Lignin can be separated from the black liquor by different, techniques including e.g. precipitation and filtration. Lignin usually begins precipitating at pH values below 11-12. Different pH values can be used in order to precipitate lignin fractions with different properties. These lignin fractions differ from each other by molecular weight distribution, e.g. Mw and Mn, polydispersity, hemicellulose and extractive contents. The molar mass of lignin precipitated at a higher pH value is higher than the molar mass of lignin precipitated at a lower pH value. Further, the molecular weight distribution of lignin fraction precipitated at a lower pH value is wider than of lignin fraction precipitated at a higher pH value. The precipitated lignin can be purified from inorganic impurities, hemicellulose and wood extractives using acidic washing steps. Further purification can be achieved by filtration.

The term “enzymatic lignin” (EH) should be understood in this specification as lignin from enzymatic hydrolysis process of lignocellulosic biomass. In the enzymatic hydrolysis process, the cellulose is hydrolysed by enzymes into carbohydrates and the unhydrolyzed solid residue comprises the lignin. The lignin can be purified, if needed. EH lignin separated from pure biomass is essentially sulphur-free (sulphur content less than 3%). Preferably, biomass is pre-treated to remove hemicelluloses and thereafter the cellulose is hydrolysed.

The term “dispersion” should be understood in this specification as the dispersion which is formed when lignin is dispersed in water during the preparation of the coating dispersion of the disclosure.

The term “readily biodegradable” should be understood in this specification as a compound assumed to be biodegradable, i.e. to undergo rapid and ultimate biodegradation (“mineralisation”) in the environment. If a compound is considered readily biodegradable no further investigation of the chemical itself, or of the possible environmental effects of transformation products, is required. In other words, compounds passing screening tests (for example OECD TG 301 B, C, D, F and 310 with a duration extension up to 60 days, according to the Annex to Background Document to the Opinion on the Annex XV dossier proposing restrictions on intentionally added microplastics of December 2020 (Committee for Risk Assessment (RAC), Committee for Socio-economic Analysis (SEAC))) are considered not to offer a serious challenge to the metabolic capability of aerobic aquatic environments and are considered to be readily degraded in the real environment. Further, although some natural polymers, such as lignin, do not pass all the test of the biodegradability standard, natural polymers which has not been chemically modified are considered an exemption and therefore lignin as such is considered to fulfil the biodegradability criteria. Typically, lignin slowly biodegrades in water and soil (80-98 wt %, half-life of 1 month-1 year). For example, Kraft lignin and other “isolated lignin” are also considered as natural polymers and covered by the exemption as long as the lignin has not been further chemically modified once it has been isolated using the different processes to extract it.

The term “hydrophobic outward layer” should be understood in this specification as a being the most external layer of the coated fertilizer product which has a surface that repels water. The term “hydrophobic” means that the surface is water repelling and resists wetting. Also, generally hydrophobic means that hydrophobic surfaces are low energy surfaces which repel water. Hydrophobic molecules are usually nonpolar, meaning the atoms that make the molecule do not produce a static electric field. Test methods for detecting the presence of hydrophobic (non-wetting) films on surfaces include visual (appearance), contact angle (static, dip coated on glass slide), immersion (elevated & reduced temperature), temperature & humidity exposure, salt spray/fog for corrosion resistance, refractive index, glass transition temperature (Tg), thermal stability, dielectric strength, dielectric constant, dissipation factor, solder-through capability, UV exposure and moisture & insulation resistance (MIR).

In embodiments of the disclosure the coating of the coated fertilizer product, and the coating of the coated fertilizer prepared according to the method of the disclosure, consists of readily biodegradable components and/or natural polymers. This should be understood in this specification as containing no microplastics and no organic solvents.

The term “controlled-release fertiliser” should be understood in this specification as meaning a granulated fertiliser that releases nutrients gradually into the soil, for example within a controlled release period. Controlled-release fertilizer is also known as slow-release fertilizer.

In embodiments of the disclosure, the coating of the coated fertilizer product, and the coating of the coated fertilizer prepared according to the method of the disclosure, has an inner layer comprising lignin. Typically, this first inner layer further comprises at least one further biobased polymer, which is biodegradable, and which is not lignin, and/or a plasticizer, which is biodegradable. Optionally, the inner layer further comprises one or more substance(s), such as natural gums, preferably xanthan gum or gellan gum, as stabilizer(s) and/or thickening agent(s). In embodiments of the disclosure, the biobased polymer typically forms crosslinking around the lignin of the inner layer, the lignin being trapped or enchased within the biobased polymer. Preferably the biobased polymer, the plasticizer, or both the biobased polymer and the plasticizer are water-soluble.

In embodiments of the disclosure, the coating of the coated fertilizer product, and the coating of the coated fertilizer prepared according to the method of the disclosure, in addition to the inner layer, comprises at least one further layer which is a hydrophobic outward layer, preferably the hydrophobic outward layer is the most external layer. Typically, the hydrophobic outward layer is esterified fatty acid, suberin or wax, preferably chosen from the group consisting of non-flammable oils, suberin or wax, more preferably the wax is chosen from the group consisting of carnauba wax, biomere (80-130), ricebran wax and candelilla wax and most preferably the wax is carnauba wax.

In embodiments of the disclosure, a coated fertilizer product comprising a fertilizer granule core and a coating is provided. The coating comprises an inner layer comprising lignin; at least one further biobased polymer(s); and plasticizer(s). The coating also comprises an outward layer which is hydrophobic and repels water. The coating of the disclosure comprises no organic solvents and the biobased polymer and the plasticizer are biodegradable. The lignin is typically not chemically modified, and the outward layer typically comprises esterified fatty acid, suberin and/or wax. Typically, the biobased polymer(s) and/or plasticizer(s), which are biodegradable, are compounds contains no microplastics and which pass screening tests for biodegradability (for example OECD TG 301 B, C, D, F and 310 with a duration extension up to 60 days, according to the Annex to Background Document to the Opinion on the Annex XV dossier proposing restrictions on intentionally added microplastics of December 2020 (Committee for Risk Assessment (RAC), Committee for Socio-economic Analysis (SEAC))), are natural polymers, or natural polymers which has not been chemically modified.

In preferred embodiments of the disclosure, the coating of the coated fertilizer product, and the coating of the coated fertilizer prepared according to the method of the disclosure, comprises at least two different layers, preferably a two-layer coating is obtained by a two-layer process according to the method of the disclosure.

In embodiments of the disclosure, the coating of the coated fertilizer product, and the coating of the coated fertilizer prepared according to the method of the disclosure, is 1-25 wt % of the total weight of the coated fertilizer product, preferably 5-20 wt %, more preferably 8-16 wt % of the total weight of the coated fertilizer product, including the amount of coating being between two of the following amounts: 1, 2, 3, 4, 5, 6, 7, 8, 9, 10, 11, 12, 13, 14, 15, 16, 17, 18, 19, 20, 21, 22, 23, 24 and 25 wt % of the total weight of the coated fertilizer product. The thickness measured by Scanning electron microscopy (SEM) typically ranges from 20 to 225 μm. The thickness varies according to the shape of the specific granule since typical fertilizer granules are not perfectly spherical. Normally performance improves when thickness of the coating increases. Typically, the hydrophobic outward layer forms a smaller (wt %) and/or thinner (μm) part of the coating.

In embodiments of the disclosure, the method for preparing a coated fertilizer comprises
a) providing a coating dispersion comprising lignin, at least one further biobased polymer and plasticizer, wherein the lignin is not chemically modified and wherein the biobased polymer and the plasticizer are biodegradable;
b) coating fertilizer granules by the coating dispersion to provide a coating inner layer and obtaining a one-layer coated fertilizer;
c) coating the one-layer coated fertilizer with an outward layer and
d) obtaining coated fertilizer, and wherein no organic solvents are used in the coating. Typically, the outward layer is hydrophobic.

In embodiments of the disclosure, the coating dispersion is prepared from a mixture comprising at least lignin, biobased polymer, plasticizer, and water and wherein the biobased polymer and the plasticizer are biodegradable. Typically, the coating dispersion is prepared by heating a mixture comprising lignin, biobased polymer, plasticizer, and water to 70 to 120° C. or by heating water to 70 to 120° C. and then adding a mixture comprising lignin, biobased polymer, and plasticizer. Lignin particles of the lignin does not dissolve but is dispersed into the mixture. Preferably, the amount of lignin is between 5 and 15 wt %, preferably 8-10 wt %, the amount of biobased polymer is between 1 and 10 wt %, preferably 3-5 wt %, the amount of plasticizer is between 0.5 and 5 wt %, preferably 0.5-2.5 wt % and the amount of water is between 70 and 93.5 wt %, preferably 77.5-86 wt % of the coating dispersion. Optionally, the mixture further comprises stabilizer(s) and/or thickening agent(s), such as natural gum, preferably gellan gum or xanthan gum, preferably the amount of stabilizer(s) and/or thickening agent(s) is 0.001-0.005 wt %, preferably 0.0025-0.005 wt %. Typically, the temperature is the boiling point of water and the temperature depend on the pressure. For example, at 120° C. the pressure is 2 bar. Preferably, the coating dispersion is prepared by stirring the mixture for 10 minutes to 2 hours, preferably between 10 and 60 minutes, more preferably between 10 and 40 minutes, most preferably between 15 and 35 minutes using any conventional mixers or stirrers.

In embodiments of the disclosure, the hydrophobic outward layer is typically esterified fatty acid, suberin or wax emulsion, preferably chosen from the group consisting of non-flammable oils, suberin or wax emulsion, more preferably the wax emulsion wax is chosen from the group consisting of carnauba wax, biomere (80-130), ricebran wax and candelilla wax, most preferably the wax is carnauba wax.

In embodiments of the disclosure, the quantity of coating dispersion sprayed compared to fertilizer is typically from 0.1 to 1, preferably 0.3 to 0.7 parts per weight. The quantity of compound sprayed for the hydrophobic outward layer, preferably a wax emulsion is typically from 0.05 to 1, preferably 0.1 to 0.25 wt % parts per weight.

In embodiments of the disclosure, the fertilizer granules are typical commercial products, normally multi-nutrient granular fertilizers where each granule contains the nutrients in the ratio required for a specific use. Typically, fertilizers are composed of nitrogen, phosphorus, and potassium compounds, vital for plant growth.

In embodiments of the disclosure, the coating is typically performed by spray coating, preferably drum, turning pan or fluidized bed coating, more preferably fluidized bed coating.

In embodiments of the disclosure, the biobased polymer, which is biodegradable, used for the coated fertilizer product, and the coated fertilizer prepared according to the method of the disclosure, is typically chosen from the group consisting of polyvinyl alcohol (PVOH), polybutylene succinate (PBS), polyhexamethylene succinate (PHS), polyglycolide (PGA), polyhydroxyalkanoates (PHA), polylactide (PLA), polycaprolactone Capa and poly (butylene adipate-co-terephthalate) (PBAT), preferably PVOH.

In embodiments of the disclosure, the plasticizer, which is biodegradable, used for the coated fertilizer product, and the coated fertilizer prepared according to the method of the disclosure, helps to keep the mixture in the form of a dispersion. The biodegradable plasticizer is typically chosen from the group consisting of polyethylene glycol (PEG), propylene carbonate, epoxidized cardanol, acetylated castor oil, methyl epoxy soyate, dibutyl phthalate and triethyl citrate, preferably polyethylene glycol 6000 (PEG 6000)

In embodiments of the disclosure, the coated fertilizer product, and the coated fertilizer prepared according to the method of the disclosure, is a controlled release fertilizer product, preferably the controlled fertilizer product has a controlled release period over over 4 days, preferably over 30 days, more preferably over 3 months and most preferably over 6 months. Typically, the controlled release fertilizer product has a release rate at 23° C. and 50% relative humidity below 8 mS/cm, preferably below 6 mS/cm, more preferably below 4 mS/cm after 96 hours. Typically, the weight loss of the controlled release fertilizer product is below 40 wt % of the total dry matter, preferably below 20, more preferably below 18 wt %, most preferably below 15 wt % after 96.

### EXAMPLES

### Example 1 Preparing Lignin Coating

A one-pot method was applied for preparation of the formulations.

The appropriate quantities of lignin (KL, Kraft lignin powder (80-98 wt %), with a pH of 2.5-4.5 (10% solution) or EH, enzymatic hydrolysis lignin), PEG 6000 (solubility=1.2 g/mL at 20° C.; biodegradability aerobic—Exposure time 28 d, Result: 74,85%—Readily biodegradable. (OECD Test Guideline 301 D)), PVOH (Exceval, biodegradable, purity >94%; solubility=10-99%), xanthan gum and optional wax (anionic carnauba wax) where mixed dry and subsequently fed into an excess of water at 100° C. with continuous stirring. The weight ratios of Lignin: PEG:PVOH was 1:0.25:0.5 (200 g: 50 g: 100 g). Further, xanthan gum was added at a ratio of 0.025 (EHNM(15), and EHNM+CW) or 0.05 (KLNM_2X(15) and KLNM_2X+CW) and wax was added to some of the mixtures (EHNM+CW and KLNM_2X+CW) at a ratio of 0.5. There was an excess of water of about 100 g to compensate for evaporation during mixing. Stirring was kept for about 30 minutes to ensure the dissolution of soluble compounds and the formation of a homogeneous mixture.

The features of the coatings and the coated fertilizers are listed in Table 1.

TABLE 1
Features of coatings and coated fertilizers

| | Total | Quantity | | Total mass | |
|---|---|---|---|---|---|
| | solids | sprayed | Fertilizers | retrieved | Coating |
| | (wt %) | (g) | (g) | (g) | (wt %) |
| CW_1 | 25.00 | 199.4 | 500 | 548.4 | 9.68 |
| EHNM(15) | 21.40 | 378.2 | 500 | 573.6 | 14.72 |
| KLNM_2X(15) | 22.59 | 360.2 | 500 | 567.0 | 13.40 |
| EHNM + CW | 23.35 | 301.0 | 500 | 570.4 | 14.08 |
| KLNM_2X + | 14.24 | 354.6 | 500 | 554.0 | 10.08 |
| CW | | | | | |
| CW_KLNM_2X | 25.00 | 203.2 | 500 | 543.0 | 8.60 |
| CW_EHNM(15) | 25.00 | 317.0 | 500 | 578.2 | 15.64 |

Wherein the coatings of Table 1 have the following features:
CW_1=One-layer coating, only wax
EHNM (15)=One-layer coating, comprising Enzymatic hydrolysis lignin
KLNM_2X (15)=One-layer coating, comprising Kraft lignin
EHNM+CW=One-layer coating, comprising Enzymatic hydrolysis lignin and wax
KLNM_2X+CW=One-layer coating, comprising Kraft lignin and wax
CW_KLNM_2X=Two-layer coating: inner layer KLNM_2X, outer layer wax
CW_EHNM (15)=Two-layer coating: inner layer EHNM (15), outer layer wax

The coating dispersions were fed into a fluidized bed coater (The Neuhaus Neotec Laboratory Fluid Bed Center LFB) for coating of fertilizer granules.

The fertilizer granules used in the example were commercial, multi-nutrient fertilizer granules.

The two-step coating was achieved by feeding 10 wt-% of anionic carnauba wax emulsion [25% solid content; pH=10; viscosity (23° C.)=150 mPa·s] into the fluidized bed coater (The Neuhaus Neotec Laboratory Fluid Bed Center LFB) for coating of the fertilizer granules already coated by the coating dispersion comprising lignin (EHNM(15) and KLNM_2x(15)).

### Slow-Release Behaviour in H₂O

The slow-release behaviour of the coating was analysed by placing 1 g of uncoated fertilizer granules (REF) and different coated fertilizer granules in a 100 mL of H₂O. The samples were kept in a room conditioned at 23° C. and 50% relative humidity. A water dissolution method was used for evaluation of controlled release. Conductivity of the granule-H2O solution was measured according to standard SFS-EN 27888 (1994). Weight loss was calculated over 4 days by removing the liquid and drying the solids at 60° C. for 12 h, followed by weighing.

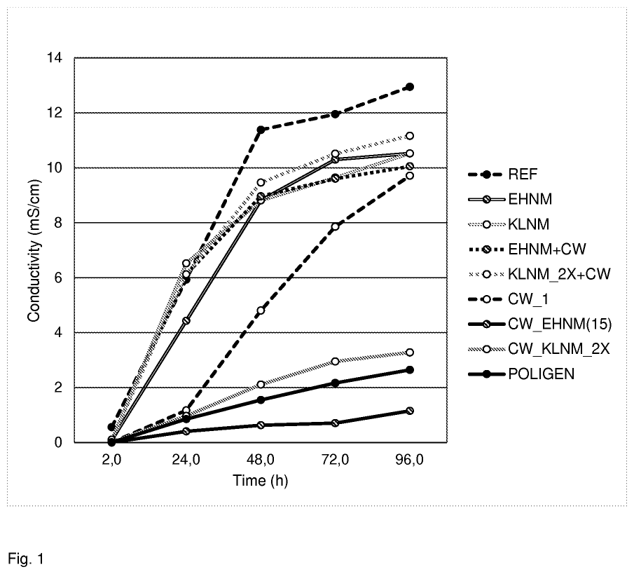

FIG. 1 shows conductivity as a function of time of selected samples in water for a period of 4 days (96 h). The release rate for two-step coated granules (named CW_KLNM_2X and CW_EHNM(15)) was compared to samples with fertilizer without coating (named REF), one-layer coating without wax (named EHNM(15) and KLNM_2x(15)), one-layer coating with a mixture comprising wax (named EHNM+CW and KLNM_2X+CW), one-layer coating comprising only wax (named CW_1), and a commercial polyethylene fertilizer coating (named Poligen).

As can be seen from FIG. 1 the release rate (conductivity against time) of the two-step coating (CW_KLNM_2X and CW_EHNM(15)) shows a significant improvement on the release rate of ions from the fertilizer granules when compared to the reference sample and any of the one-layer coatings. The one-layer coatings showed no significant reduction in the release rate. The release rate of the one-layer coating with EH or KL lignin (EHNM(15) and KLNM_2x(15)) or with mixtures of KL or EH lignin and carnauba wax (EHNM+CW and KLNM_2X+CW) showed only slight improvement on the release rates compared to the reference fertilizer without coating (REF). After 24 h the release rate of only wax (CW_1) was also comparable to the other one-layer coated fertilizers. The results obtained for the two-layer coatings were comparable to the results of the commercial grade polyethylene fertilizer coating (Poligen).

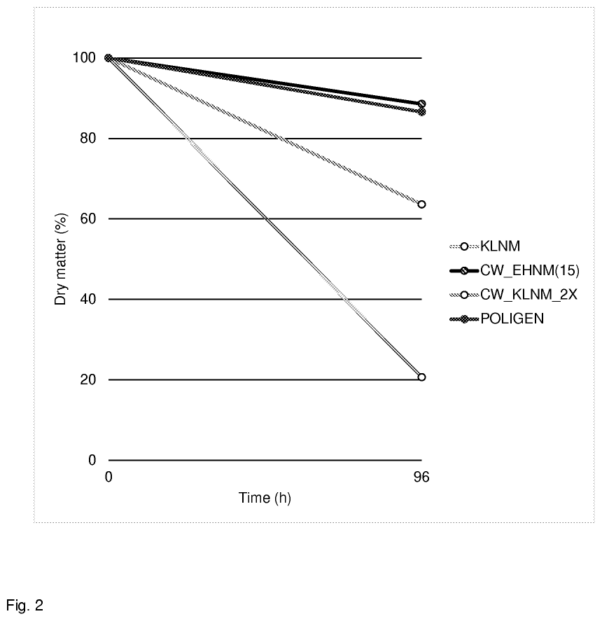

FIG. 2 shows the relative dry matter remaining after 4 days (96 h) in water of some of the samples. The weight loss of the coated fertilizers was in correlation with the result obtained from the conductivity measurements.

ICP-MS (Inductively Coupled Plasma Mass Spectroscopy) was used to identify the ions present in the solutions. As can be seen from Table 2, the results from the ICP-MS for potassium and phosphorus in particular correlate with the results obtained from both conductivity and weight loss measurements.

TABLE 2
Ion content of selected coated samples

| Ions (mg/L) | REF | Poligen | CW_EHNM (15) | EHNM + CW |
|---|---|---|---|---|
| Calcium | 106 | 3.02 | 5.47 | 15.9 |
| Potassium | 1155 | 214 | 126 | 281 |
| Magnesium | 81.4 | 10.8 | 9.42 | 21.2 |
| Sodium | 16.3 | 3.78 | 1.85 | 4.5 |
| Phosphorus | 244 | 42.5 | 27.3 | 61.8 |
| Sulphur | 622 | 94.4 | 60.9 | 142 |

Further tests (not mentioned above), showed that the conductivity for a sample with a first layer of wax and a second layer of a coating dispersion comprising lignin, was in line with a one-layer coating by only wax.

### Morphology & Thickness Analysis

Scanning electron microscopy (SEM) and Stereomicroscopy was used in the morphological analysis. The thickness of coating layers was estimated using SEM. Three random granules were chosen and morphologically analysed by SEM and Stereomicroscopy. Rough estimation of thickness was done by cutting a granule in half, fix to a support and analysed by SEM.

The thickness for a one-layer coating comprising wax varied between 86 μm and 132 μm and thickness of the coating of a two-layer coating varied between 102 μm and 142 μm.

1. A coated fertilizer product comprising a fertilizer granule core and a coating wherein the coating comprises an inner layer comprising lignin; a biobased polymer; and a plasticizer, and an outward layer, wherein the coating comprises no organic solvents, wherein the biobased polymer and the plasticizer are biodegradable, wherein the lignin is not chemically modified, and wherein the outward layer is hydrophobic.

2. The product according to claim 1, wherein the coated fertilizer product is a controlled release fertilizer product having a controlled release period over 4 days.

3. The product according to claim 1, wherein the biobased polymer forms crosslinking around the lignin of the inner layer.

4. The product according to claim 1, wherein the biobased polymer is water-soluble.

5. The product according to claim 1, wherein the plasticizer is water-soluble.

6. The product according to claim 1, wherein the outward layer is esterified fatty acid, suberin or wax.

7. The product according to claim 1, wherein the coating is 1-25 wt % of the total weight of the coated fertilizer product.

8. The product according to claim 1, wherein the controlled release fertilizer product has a release rate at 23° C. and 50% relative humidity below 8 mS/cm after 96 hours.

9. The product according to claim 1, wherein a weight loss of the coated fertilizer product is below 40 wt % of the total dry matter after 96 hours.

10. A method for preparing coated fertilizer comprising
a) providing a coating dispersion comprising lignin, a biobased polymer and a plasticizer, wherein the lignin is not chemically modified and wherein the biobased polymer and the plasticizer are biodegradable;
b) coating fertilizer granules by the coating dispersion to provide a coating inner layer and obtaining a one-layer coated fertilizer;
c) coating the one-layer coated fertilizer with an outward layer, which is hydrophobic and
d) obtaining the coated fertilizer,
and wherein no organic solvents are used.

11. The method according to claim 10, wherein the coating dispersion is prepared by heating a mixture comprising the lignin, the biobased polymer, the plasticizer and water to 70 to 120° C. or by heating water to 70 to 120° C. and then adding a mixture comprising the lignin, the biobased polymer, the plasticizer and optionally a stabilizer(s) and/or a thickening agent(s).

12. The method according to claim 11, wherein the mixture is mixed for 10 minutes to 2 hours.

13. The method according to claim 11, wherein the lingin is in an amount between 5 and 15 wt %, the biobased polymer is in an amount between 1 and 10 wt %, the plasticizer is in an amount between 0.5 and 5 wt %, and the water is in an amount between 70 and 93.5 wt %.

14. The method according to claim 10, wherein the coating is a spray coating or a fluidized bed coating.

15. The method according to claim 10, wherein the outward layer is an esterified fatty acid, a suberin or a wax emulsion.

16. The product according to claim 1, wherein the biobased polymer is chosen from the group consisting of polyvinyl alcohol (PVOH), polybutylene succinate (PBS), polyhexamethylene succinate (PHS), polyglycolide (PGA), polyhydroxyalkanoates (PHA), polylactide (PLA), polycaprolactone Capa and poly (butylene adipate-co-terephthalate) (PBAT).

17. The product according to claim 1, wherein the plasticizer is chosen from the group consisting of polyethylene glycol (PEG), propylene carbonate, epoxidized cardanol, acetylated castor oil, methyl epoxy soyate, dibutyl phthalate and triethyl citrate.

18. The product according to claim 1, wherein the biobased polymer and/or plasticizer are biodegradable, and are compounds passing screening tests OECD TG 301 B, C, D, F and 310 with a duration extension up to 60 days, according to the Annex to Background Document to the Opinion on the Annex XV dossier proposing restrictions on intentionally added microplastics of December 2020 (Committee for Risk Assessment (RAC), Committee for Socio-economic Analysis (SEAC)), are natural polymers, or natural polymers that have not been chemically modified.

19. (canceled)
